(19) United States
(12) Patent Application Publication
(10) Pub. No.: US 2016/0295264 A1
(43) Pub. Date: Oct. 6, 2016

(54) System and Method for Generating and Sharing Compilations of Video Streams

(71) Applicant: Steven Yanovsky, New York, NY (US)

(72) Inventor: Steven Yanovsky, New York, NY (US)

(21) Appl. No.: 15/059,184

(22) Filed: Mar. 2, 2016

Related U.S. Application Data
(60) Provisional application No. 62/126,975, filed on Mar. 2, 2015.

(51) Int. Cl. H04N 21/2668; H04N 21/41; H04N 21/462; H04N 21/63; H04N 21/482; H04L 29/08

(52) U.S. Cl. CPC H04N 21/2668; H04N 21/482; H04L 67/10; H04N 21/4622; H04N 21/632; H04N 21/4126

(57) ABSTRACT

A method for displaying a compilation of video clips, comprising by a user, accessing an application for uploading video clips and displaying a video stream the application capable of being associated with the user and with a social media application including other users identified with the user the application further having one or more channels each representing an affinity, by the user, selecting a channel in the application, by the application, compiling a stream of video clips uploaded by the other users identified with the user to a selected channel, and by the application, displaying the stream of video clips.

### RELATED APPLICATIONS

The present invention is a Non-Provisional application of U.S. Patent Application No. 62/126,975, filed on Mar. 2, 2015. All descriptions, drawings and teachings set forth therein are expressly incorporated by reference and a claim of priority upon the teachings is expressly made herein.

### FIELD OF THE INVENTION

The present invention relates to the field of social media, digital video, mobile and multi-channel video networks and systems, and more particularly, to a methodology and interface that captures visual media, such as photographs and videos. The present invention is an apparatus and method for aggregating and transforming video moments in real-time into infinite video mashups for sharing on Internet and mobile social networks. More particularly, this invention relates to single mode video capture of media that alternately produces videos. Specifically, the present invention users to shoot, post and share video clips of a common interest or affinity into specific channels based on those interests or affinities and view them in aggregate on each channel.

### BACKGROUND OF THE INVENTION

Many social mobile video platforms exist today, including YouTube, Instagram, Snapchat, YouNow, Meerkat, Periscope and Vine, which host videos of varying lengths and content of user-generated content, including photos, videos, images and text, on computer, websites, mobile websites and through smartphone applications with purportedly unique dynamic parameters. Many of these products or systems are identified as social networks as they involve unique user names, personalized data, image and video feeds, location identifiers, social sharing and commenting. The present invention provides an advantage over prior products and systems by enabling user-generated videos to be uploaded by users to dedicated, affinity-based video channels curated by the system in real-time, which aggregates and daisy chains the submitted videos into a video mashup, over a bed of music or song(s). Further, the invention allows users to control the collection of videos they see within each channel that are uniquely identified as Facebook Friends. No product, system or application on the market has allowed consumers to filter video content in a stream according to those identified as Facebook Friends, most liked videos, or other videos by specific identifiers without the need for hashtags.

In addition, no product, system or application on the market has successfully engaged consumers with their favorite brands; instead these prior platforms rely on stand-alone advertisements inserted before or during displayed videos to generate advertising revenue. Further, no current platform allows consumers to join or become an integrated part of their favorite brands' video content.

### SUMMARY OF THE INVENTION

In general in one aspect, exemplary embodiments of the present invention may provide a method for displaying a compilation of video clips, comprising by a user, accessing an application for uploading video clips and displaying a video stream the application capable of being associated with the user and with a social media application including other users identified with the user the application further having one or more channels each representing an affinity, by the user, selecting a channel in the application, by the application, compiling a stream of video clips uploaded by the other users identified with the user to a selected channel, and by the application, displaying the stream of video clips. Implementations of the various exemplary embodiments of the present invention may include one or more of the following features: The music is a pre-selected song. The compiling further comprises randomly selecting video clips uploaded by the other users identified with the user. By the user, uploading a video clip to the selected channel in the application. The compiling further comprises including the video clip uploaded by the user. By an administrator, receiving the video clips uploaded to the selected channel and altering the complied stream of video clips. The stream is a real time, continuous stream.

In general in one aspect, exemplary embodiments of the present invention may provide a method for displaying a compilation of video clips, comprising by a user, accessing an application for uploading video clips and displaying a video stream, the application capable of being associated with the user and with a social media application including other users identified with the user, the application further having one or more channels each representing an affinity, by the user, selecting a channel in the application, by the application, compiling a stream of video clips uploaded by the other users identified with the user and third-party users to a selected channel, and by the application, displaying the stream of video clips. Implementations of the various exemplary embodiments of the present invention may include one or more of the following features: The application includes a filter for selecting attributes of video clips that may be compiled, further comprising, by the user, selecting the filter on the application. The compiling further comprises randomly selecting video clips from among the video clips having the selected attributes. The filter selects video clips uploaded by other users identified with the user. The filter selects a combination of video clips uploaded by other users identified with the user and video clips uploaded by third-party users. The displaying further comprises playing music. The music is a pre-selected song. By the user, uploading a video clip to the selected channel in the application. The compiling further comprises including the video clip uploaded by the user. By an administrator, receiving the video clips in the selected channel and altering the complied stream of video clips.

In general in one aspect, exemplary embodiments of the present invention may provide a method for displaying a compilation of video clips, comprising providing an application for uploading video clips and displaying a video stream, the application capable of being associated with the user and with a social media application including other users identified with the user, the application further having one or more channels each representing an affinity, compiling a stream of video clips uploaded by the other users identified with the user to a selected channel; and displaying the stream of video clips.

In general in one aspect, exemplary embodiments of the present invention may provide a method for displaying a compilation of video clips, comprising providing an application for uploading video clips and displaying a video stream, the application capable of being associated with the user and with a social media application including other users identified with the use, the application further having one or more channels each representing an affinity, compiling a stream of video clips uploaded by the other users identified with the user and third-party users to a selected channel, and displaying the stream of video clips.

In general in one aspect, exemplary embodiments of the present invention may provide a system for displaying a compilation of video clips, comprising a device for implementing an application for uploading video clips, the device comprising a display, a processor, and a memory, an application for uploading video clips and displaying a video stream, the application capable of being associated with the user and with a social media application including other users identified with the user, the application further having one or more channels each representing an affinity wherein the application is configured to upload a video clip to a selected channel from the memory, compile a stream of video clips uploaded by the user and by the other users identified with the user to the selected channel and display on the display the stream of video clips to the selected channel.

In general in one aspect, exemplary embodiments of the present invention may provide a system for displaying a compilation of video clips, comprising a device for implementing an application for uploading video clips, the device comprising a display, a processor, and a memory,an application for uploading video clips and displaying a video stream; the application capable of being associated with the user and with a social media application including other users identified with the user the application further having one or more channels each representing an affinity, wherein the application is configured to upload a video clip to a selected channel from the memory, compile a stream of video clips uploaded by the other users identified with the user and third-party users to the selected channel, and display on the display the stream of video clips.

In general in one aspect, exemplary embodiments of the present invention may provide a system for displaying a compilation of video clips on a remote user device over a communications network, comprising a storage device for storing video clips uploaded by a user and by other users identified with the user via a social media application to a selected channel, a processor for compiling a stream of video clips stored in the storage device, a communications module for receiving the uploaded video clips and for transmitting the stream of video clips to the remote user device over the communications network.

### BRIEF DESCRIPTION OF THE DRAWINGS

FIG. 1 illustrates a network in accordance with an embodiment of the present invention;

FIG. 2 illustrates an embodiment of the interface of a user smartphone in accordance with the present invention; and

FIG. 3 illustrates an embodiment of the channels of the present invention.

### DETAILED DESCRIPTION OF THE PREFERRED EMBODIMENTS

The present invention relates to a system and method for curating and aggregating user-generated video content into mashup videos around a bed of music. The invention involves a mobile social media platform and viewing experience in which individuals shoot and upload native video clips that are aggregated into a video stream based on “affinities”, e.g., “shared interests”, “life experiences”, “events”, “sports and teams”, “TV Shows”, “Movies” “memes”, “holidays” and “pop-culture moments”. The invention presents these “affinities” as “Fan Channels”.

Each Fan Channel aggregates the submitted videos in real-time, and streams them back through the channel daisy-chained together as a mashup-video, during which a particular song or music bed is played.

The present invention is implemented through a smart phone/ tablet application (app), as well as desktop top computer. The system may be implemented in HTML5, Drupal or other computer programing languages.

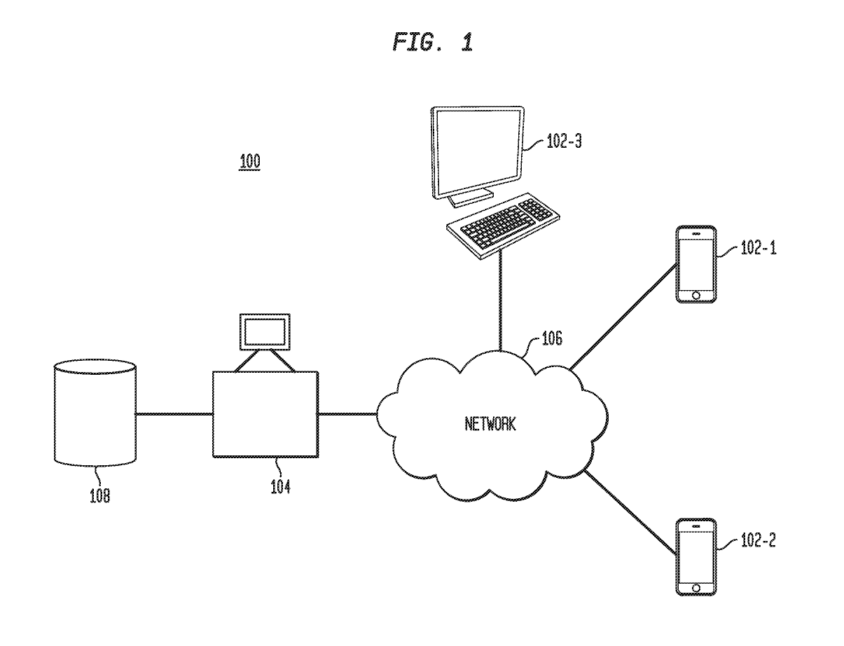

FIG. 1 illustrates a system 100 configured in accordance with an embodiment of the present invention. The system 100 includes a set of client devices 102_1 through 102_N and at least one server 104 connected via a network 106, which may be any wired, wireless or a cloud-based network including the Internet and cellular networks. Each client device 102 may be a computer, tablet, smartphone or desktop computer and the like with standard components including a central processing unit, an interface with a display and associated input/output devices, and a network interface or communications circuit. The input/output devices may include a touch display, keyboard, mouse and the like. The network interface or communications circuit provides connectivity with network 106.

Server 104 also includes a central processing unit, an interface with a display and associated input/output devices, and a network interface or communications circuit. Server 104 is also connected to a memory 108. The memory 108 stores standard components, such as a browser, web browser or mobile app which allow the user to access a social networking site, such as the social networking site hosted on server 104 in connection with the present invention. The memory 108 stores modules of executable instructions to implement disclosed operations. For example, the memory 108 may store a social networking module, which supports standard social network operations, such as hosting profile pages, maintaining social graphs for individual users, and facilitating communication between the individual users.

The memory 108 also stores a profile access module. The profile access module includes executable instructions to implement operations of the present invention. In particular, the profile access module includes executable instructions to allow a user to manipulate an interface element to establish single action control of social networking profile access. The interface element may be any object (e.g., box, bar, line, circle) that partitions one set of information from another set of information.

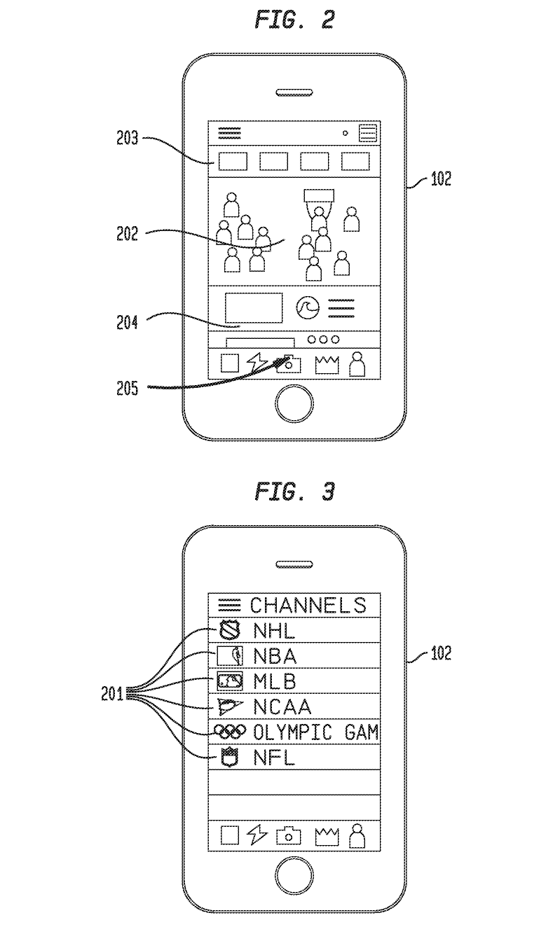

The present invention provides users with a stream of user-submitted video clips initially organized by a classification that categorizes video clips uploaded to the system by areas of interest or affinities. Affinities are identified and presented as individual Channels (See FIG. 2, 201) that are associated with categories such as Sports, Music, TV, Movies, Memes, Holidays, Music, Life Experiences, Cultural Movements and Seasonal Events. Examples of Channels are NFL, NBA, NHL, MLB, March Madness, NCAA College Football, World Cup, Olympics, X Games Freestyle, Red Bull Radical, Dew Skate Stunts, Game of Thrones, Star Wars, Walking Dead, Christmas Kisses, Halloween Scares, Christmas Kisses, Purina Pet Tricks, Catching Fish, Ice Bucket Challenge, Dance Like Uma, Gangham Style, Crazy Baby Faces, Mother's Day Hugs, I Got Into College!, etc. A channel 201 shows users on their client devices 102_1 through 102_N a continuously updated series of video clips 202 presented as a compilation pertaining to the specified affinity, and preferably played with a background of music, i.e., a pre-selected song.

In embodiments in which the invention is a software module, such as an app or computer program, the software may be downloaded to a user's client device via the Internet or other method of transferring downloadable software and data. Once the software module is downloaded, the user will create a profile using an existing Facebook Account or an identifiable email address username and password that uniquely identifies the user. The Facebook API is currently employed by the present invention . Users must connect to the present invention using their Facebook username to engage with the present invention. When the user has created a profile based on a social networking or email account, the system of the present invention will be able to identify other previously existing users on the system that the user knows based on the user's online social network. For example, if the user creates a profile using his Facebook account, the invention will identify other users of the system to whom the user is connected via Facebook as “Friends” through an API with Facebook. If the user creates an account with email, the system of the present invention may identify other related users of the system from the user's email contacts.

When the user opens the app, program, or website hosting the system, he may select a channel 201 from a list of available channels, as shown in FIG. 3, by clicking or tapping on an icon or interface element representing a channel. As described above, each channel or affinity is presented as its own user interface in groups for ease of browsing. For example, there may be a tab on the interface that lists sports-related channels that may be chosen, such as for Major League Baseball, March Madness, the Buffalo Bills, or the Olympic Games. Further, when a user would like to look up a favorite team, for example, he might select the Sports Channel tab, then the NFL tab, and then the channel for his favorite team. The Channels tab may include other interests and brands, such as cooking, fashion, charities etc.

Once a user has selected a channel 201, he will see a series of video clips 202, as shown in FIG. 2, related to the channel's theme presented as a compilation of user generated videos on the user interface of the device. The displayed series of video clips is preferably set to background music, such as a pre-selected song. Each video clip is, e.g., approximately six to twelve seconds in length, although the length of the video clips may vary. The channel 201 will also include a number of filters 203, preferably selectable by interface elements located above or near the video stream. The filters may be selected individually or in combination using actuatable icons on the client device interface, such as buttons labeled “Most Liked” and “Friends.” A filter narrows or tailors the feed on a channel to those video clips that satisfy the user's preferences, and thus the user may customize which videos he sees on the channel based on his selected filters. Filters 203 may represent practical preferences such as “most liked videos” or “videos uploaded by Facebook Friends,” or they may represent content preferences, such as a particular team's videos generated during a football game or videos uploaded by celebrities. Once a user has applied a filter 203 to the channel 201, the channel will only show or primarily show the video clips that meet the characteristics specified by the filters.

Video clips entered into a particular channel may be played sequentially in a random or non-random fashion. For example, the system may display to the user on his client device a stream of video clips uploaded only by his Friends. Alternatively, the system may display a stream of video clips including a combination of those uploaded by the user's Friends, those selected by others as favorites or “most liked,” and those selected by or input into the system by an administrator, e.g., for promotional and marketing purposes. In a preferred embodiment, the video stream is displayed over a pre-selected song or bed of music. If there are fewer video clips than the length of the song, the system may automatically populates a video clip stream filtered to have video clips uploaded by Friends with video clips from other sources. Alternatively, if there are more video clips from Friends than can be played during the length of the song, the system may randomly select video clips uploaded by the user and his Friends for display. This attribution is controlled by the system as defined by the content management system. A weighted average of all videos by Friends, Most-Liked, School, Rivals, Celebrity or other identifiable framework is can be assigned by the administrator to ensure the best user experience.

The stream of video clips displayed on the user's client device may take the form of a video mashup. A video clip uploaded by the user or any one of his Friends will be included in the stream of video clips. Moreover, any user and his Friends may add an unlimited number of video clips to a particular channel. The ability to upload video clips to the system is not necessarily limited by the location of the client devices. In general, in this manner, the stream of video clips available to be displayed to the user is continuously evolving, and will provide a unique display experience at any particular time. It can be described as an “Infinite Temporal Loop” whereby each time a video is submitted, it is added to the video mashup stream. In any event, a user may control the display of video clips by turning on/off specific “filters”.

In a preferred embodiment, there are two constant filters; the “Friends” filter and the “Most Liked” filter. The user is able to turn either of them on or off. The user may turn on just Friends as long as his client device is connected to the associated social media application, such as Facebook.

In a preferred embodiment, the user's interface also shows a list of thumbnails of recently uploaded videos 204, which may be displayed below or near the main channel feed. This list changes in real time. If a user sees a video on this list of recently uploaded videos that he is interested in examining, he can click or tap on the video's thumbnail to add the clip to his channel 201, to mark it as a favorite, or to obtain details about the video. Video details may include username, name of video (as described by user), number of views, number of likes or brand/ad identifier. For example, the administrator of the specific channel of the present invention may designate that when a user clicks the “like” or “favorite” button of one or more of specific videos containing an icon, mascot, code or other visual identifier, that video clip as a favorite will trigger the activation of a coupon or promotion within the invention, collected and listed into a folder within the user profile deemed “Contests”, “Offers”, “Redemptions”, “Coupons”, Promo Codes” that can be redeemed by the user according to the tenets of the offer.. This preferred embodiment further provides a folder within the app separate from the channel feed to store coupons or promo codes, which may be scannable, e.g., by QR code or other machine readable code, for later use. The folder is easily accessible in the Profiles area of the user interface , and the coupon may be called up by the user when he is ready to use it. Video clip details can also provide links to purchase items featured in the video, including links to other apps, such as those in Apple Corp.'s iTunes Store. In the situation where a channel 201 is based on or features a song, album, or musical band, a link to download or buy music may be positioned on the interface underneath or near the main video clip compilation stream 202 for downloading or purchase at any time.

A user may upload his own video clips to the app by either uploading a video from the memory of a device or a video hosting website, such as YouTube or Vimeo, or, in a preferred embodiment, shooting a transcoded video using the client device and downloaded directly into the app itself using the client device's camera function 205. The user may activate the video clip uploading feature through an actuatable icon on the client device interface, e.g., a button labeled “Add My Video.” The user's video clip is then uploaded to the channel that has been selected and is open on the client device's interface, or the user chooses a channel 201 which generally represents the content of the video clip, and in either case the video clip is added to the channel's stream of video clips. The user may upload an infinite number of video clips, and all video clips uploaded are added to the video stream compilation 202. Friends of the user and others may then see the user's video streamed in the video compilation 202 of the channel along with other video clips. Like in other apps, users can share that they uploaded or posted a video through dedicated shared links via text, SMS, Twitter, Facebook, Google+, Flipbpoard, Tumblr, WhatsApp, Skype, any and all social networking sites using a device operating system's general share function. The sharing feature may automatically include with transmission of the video clip with designated hashtags which would further identify the video content with the specific affinity within search engines via SEO/SEM. Further, particular video clips can be shared for further broadcast by the brand owner of the channel, e.g., by network television or at a particular venue such as on a jumbotron.

In a preferred embodiment, an administrator may monitor a channel's video clip feed 202, through a specific content management system associated with a channel. Each channel has its own content management system that is accessible using an assigned user-name and password. Within the specific content management system associated with that channel, the administrator will have access to a list showing all of the video clips that have been added to the channel. The videos enter the system immediately after they are uploaded by the user and before they are accessible to be seen by the user and other users as part of mashup within the channel. This provides the administrator with the ability to insure that egregious videos are not published for public viewing. The list may provide options to shorten, delete, rearrange, deny access, always play among other possible adjustments, for any or all of the videos. Monitoring the channels in this manner provides the administrator associated with each channel, complete control over which video clips are active in the channel. For brands, networks, publishers and other entertainment IP owners that licenses channels, this provides full protection from any inappropriate content from being a part of the mashup experience for users. This monitoring also allows administrators to upload relevant, complimentary videos that are in line with the objectives.

Further, it also allows the channel licensee to select to alert users whose clips have been selected for an alternative use outside of the invention itself such as using their specific video as part of a live TV broadcast of a sporting event, where the clip is of a fan cheering for his or her favorite team.

It will be understood by those of ordinary skill in the art that various changes may be made and equivalents may be substituted for elements without departing from the scope of the invention. In addition, many modifications may be made to adapt a particular feature or material to the teachings of the invention without departing from the scope thereof. Therefore, it is intended that the invention not be limited to the particular embodiments disclosed, but that the invention will include all embodiments falling within the scope of the claims.

What is claimed is:

1. A method for displaying a compilation of video clips, comprising:
by a user, accessing an application for uploading video clips and displaying a video stream;
the application capable of being associated
with the user and;
with a social media application including other users identified with the user;
the application further having one or more channels each representing an affinity;
by the user, selecting a channel in the application;
by the application, compiling a stream of video clips uploaded by the other users identified with the user to a selected channel; and
by the application, displaying the stream of video clips.

2. The method of claim 1, wherein the displaying further comprises playing music.

3. The method of claim 2, wherein the music is a pre-selected song.

4. The method of claim 1, wherein the compiling further comprises randomly selecting video clips uploaded by the other users identified with the user.

5. The method of claim 1, further comprising
by the user, uploading a video clip to the selected channel in the application.

6. The method of claim 5, wherein the compiling further comprises including the video clip uploaded by the user.

7. The method of claim 1, further comprising the step of
by an administrator, receiving the video clips uploaded to the selected channel and altering the complied stream of video clips.

8. The method of claim 1, wherein the stream is a real time, continuous stream.

9. A method for displaying a compilation of video clips, comprising:
by a user, accessing an application for uploading video clips and displaying a video stream;
the application capable of being associated
with the user and;
with a social media application including other users identified with the user;
the application further having one or more channels each representing an affinity;
by the user, selecting a channel in the application;
by the application, compiling a stream of video clips uploaded by the other users identified with the user and third-party users to a selected channel; and
by the application, displaying the stream of video clips.

10. The method of claim 9, wherein the application includes a filter for selecting attributes of video clips that may be compiled, further comprising,
by the user, selecting the filter on the application.

11. The method of claim 10, wherein the compiling further comprises randomly selecting video clips from among the video clips having the selected attributes.

12. The method of claim 10, wherein the filter selects video clips uploaded by other users identified with the user.

13. The method of claim 10, wherein the filter selects a combination of video clips uploaded by other users identified with the user and video clips uploaded by third-party users.

14. The method of claim 9, wherein the displaying further comprises playing music.

15. The method of claim 13, wherein the music is a pre-selected song.

16. The method of claim 9, further comprising
by the user, uploading a video clip to the selected channel in the application.

17. The method of claim 16, wherein the compiling further comprises including the video clip uploaded by the user.

18. The method of claim 9, further comprising the step of
by an administrator, receiving the video clips in the selected channel and altering the complied stream of video clips.

19. A method for displaying a compilation of video clips, comprising:
providing an application for uploading video clips and displaying a video stream;
the application capable of being associated
with the user and;
with a social media application including other users identified with the user;
the application further having one or more channels each representing an affinity;
compiling a stream of video clips uploaded by the other users identified with the user to a selected channel; and
displaying the stream of video clips.

20. A method for displaying a compilation of video clips, comprising:
providing an application for uploading video clips and displaying a video stream;
the application capable of being associated
with the user and;
with a social media application including other users identified with the user;
the application further having one or more channels each representing an affinity;
compiling a stream of video clips uploaded by the other users identified with the user and third-party users to a selected channel; and
displaying the stream of video clips.

21. A system for displaying a compilation of video clips, comprising:
a device for implementing an application for uploading video clips, the device comprising a display, a processor, and a memory;
an application for uploading video clips and displaying a video stream;
the application capable of being associated
with the user and;
with a social media application including other users identified with the user;
the application further having one or more channels each representing an affinity:
wherein the application is configured to:
upload a video clip to a selected channel from the memory;
compile a stream of video clips uploaded by the user and by the other users identified with the user to the selected channel; and
display on the display the stream of video clips to the selected channel.

22. A system for displaying a compilation of video clips, comprising:
a device for implementing an application for uploading video clips, the device comprising a display, a processor, and a memory;
an application for uploading video clips and displaying a video stream;
the application capable of being associated
with the user and;
with a social media application including other users identified with the user;
the application further having one or more channels each representing an affinity;
wherein the application is configured to:
upload a video clip to a selected channel from the memory;
compile a stream of video clips uploaded by the other users identified with the user and third-party users to the selected channel; and
display on the display the stream of video clips.

23. A system for displaying a compilation of video clips on a remote user device over a communications network, comprising:
a storage device for storing video clips uploaded by a user and by other users identified with the user via a social media application to a selected channel;
a processor for compiling a stream of video clips stored in the storage device;
a communications module for receiving the uploaded video clips and for transmitting the stream of video clips to the remote user device over the communications network.
